(19) United States
(12) Patent Application Publication
(10) Pub. No.: US 2026/0167100 A1
(43) Pub. Date: Jun. 18, 2026

(54) MOTOR VEHICLE HAVING OPERATING FUNCTION INDICATOR LIGHTS, AND METHOD FOR OPERATING A LIGHTING ARRANGEMENT OF A MOTOR VEHICLE

(71) Applicant: AUDI AG, lngolstadt (DE)

(72) Inventors: Thomas JOBST, Stammham (DE); Philipp ANSORG, Abensberg (DE)

(21) Appl. No.: 19/416,560

(22) Filed: Dec. 11, 2025

(30) Foreign Application Priority Data
Dec. 17, 2024 (DE) 102024138430.1

(51) Int. Cl. B60Q 1/50; B60Q 1/14; B60Q 1/30; B60Q 1/32; B60Q 1/34; B60Q 1/44

(52) U.S. Cl. CPC B60Q 1/543; B60Q 1/1415; B60Q 1/30; B60Q 1/32; B60Q 1/34; B60Q 1/44; B60Q 2400/00; B60Q 2900/30

(57) ABSTRACT

A motor vehicle having a plurality of operating function indicator lights, each of which is associated with one of a plurality of operating light functions and provided on the exterior of the motor vehicle, and a control unit for controlling the operation of the operating function indicator lights is provided, wherein the control unit is designed to control at least one of the operating function indicator lights according to a control sequence when the motor vehicle is stationary and upon presentation of a request signal, wherein the control unit is configured to select the at least one operating function indicator light to be operated according to the control sequence on the basis of selection information describing user input.

### BACKGROUND

### Technical Field

The disclosure relates to a motor vehicle having a plurality of operating function indicator lights, each of which is associated with one of a plurality of operating light functions and provided on the exterior of the motor vehicle, and a control unit for controlling the operation of the operating function indicator lights, wherein the control unit is designed to control at least one of the operating function indicator lights according to a control sequence when the motor vehicle is stationary and upon presentation of a request signal. The disclosure also relates to a computer-implemented method for operating a lighting arrangement of a motor vehicle.

### Description of the Related Art

Motor vehicles have outward-facing operating function indicator lights, which are provided for operating light functions provided for driving operation of the motor vehicle. Within the scope of this disclosure, an operating light function is to be understood as a function related to driving operation and relates to those light functions that improve the visibility of the motor vehicle for other road users and/or indicate planned driving maneuvers of the motor vehicle and/or improve visibility for a driver of the motor vehicle. Examples of such operating light functions comprise low beam, high beam (or light functions generally used to illuminate the area in front of the motor vehicle), position light, daytime running light, direction indicator light (“flashing”), cornering light, brake light, and tail light.

It is known in the prior art to utilize such operating function indicator lights even when the motor vehicle is not in operation, for example, to output a welcome animation indicating the unlocking of the motor vehicle, for example, using a key, by way of a mobile device app, and/or by detecting a corresponding device serving as a key in an unlocking area around the motor vehicle. A control unit that controls the operation of the lighting arrangement formed with the operating function indicator lights then receives an unlock signal and utilizes a predefined control sequence, stored, for example, in a storage medium, to play the welcome animation (greeting animation). Such welcome animation can comprise, for example, direction indicators flashing several times and/or headlights being activated to better illuminate the path to the motor vehicle (coming-home function). This is also useful for a person associated with the motor vehicle if the motor vehicle needs to be located, for example, if it is stationary in a large parking lot. The welcome animation can then be triggered by way of the unlock signal or another request signal, and the person's attention is drawn to the motor vehicle.

This is always problematic when several vehicles are playing the same or similar welcome animations at the same location at the same time. Such a situation can arise, for example, when participants arrive en masse at a parking lot after an event to return home in their vehicles. There is a particular risk of confusion when vehicles of the same manufacturer or even the same model need to be located. In this case, locating one's own vehicle becomes extremely difficult or even impossible due to the control sequence.

CN202211341885A discloses a method for operating vehicle lights designed to output video content, for example, as a matrix light or projector. Target content is loaded into a multimedia control unit of the motor vehicle, processed by a digital light processing control module, and output to a pixel-by-pixel controllable vehicle light associated with a multimedia system of the motor vehicle. The video can be adapted to the driver's hobbies, interests, and moods and output as a greeting to allow for personalized greeting experience.

DE102014102506A1 discloses a motor vehicle with an accent lighting arrangement. This accent lighting arrangement comprises a stack of clear-transparent panels arranged in a cavity of a lamp housing, with LEDs arranged in multiple rows and columns on a main surface of each panel. If an associated control board receives an activation signal from a device, such as a key fob, the LEDs are individually controlled to control the illumination of the LEDs according to a calibrated LED lighting sequence. Such LED lighting sequences can be downloaded from the internet, for example, and allow a logo or trademark to be displayed in a prominent position when entering or exiting the vehicle, thus providing a potential marketing benefit for the manufacturer. The vehicle can also be distinguished from other vehicle brands.

### BRIEF SUMMARY

Embodiments of the disclosure provide an easily implementable, concise way of distinguishing between different stationary motor vehicles.

In a motor vehicle of the type mentioned above, the disclosure provides that the control unit is configured to select the at least one operating function indicator light to be operated according to the control sequence on the basis of selection information describing user input.

It is therefore proposed to utilize existing operating function indicator lights that have been identified as particularly suitable due to their good recognizability and perceptibility, but to give persons associated with the motor vehicle, for example a driver, the opportunity to influence the control sequence at least as to which operating function indicator light, in particular which plurality of operating function indicator lights, should be utilized, which the driver can express through user input. This user input is provided as selection information to the control unit that controls the operation of the lighting arrangement with which the operating function indicator lights are associated, such that, at least with respect thereto, customization can be carried out and the operating function indicator lights desired by the person associated with the motor vehicle can be operated to emit light or light signals upon receipt of the request signal, which may be, for example, an unlock signal and/or a dedicated locate signal for triggering the control sequence. This eliminates the need for additional ambient or accent lighting devices and/or projectors, while clearly recognizable and assignable light signals can be output via the operating function indicator lights without having to resort to complex, difficult-to-recognize local distinguishing features such as different three-dimensional accent symbols and/or videos displayed on ground sections. Therefore, a key advantage of the present disclosure is the simplicity and clarity of its implementation, which nevertheless significantly facilitates locating one's own vehicle, especially in crowded parking lots.

In this case, operating function indicator lights are those that are provided for operating light functions when the motor vehicle is in operation, i.e., in particular those light functions that serve to improve the visibility of the motor vehicle and/or to indicate impending driving maneuvers and/or to improve the visibility of a driver of the motor vehicle. In a specific configuration of the present disclosure, it may be provided that the operating function indicator lights comprise at least one headlight and/or at least one direction indicator and/or at least one tail light and/or at least one brake light and/or at least one daytime running light and/or position light and/or the at least one operating light function comprises a low beam and/or a high beam and/or a position light and/or a daytime running light and/or a reversing light and/or a direction indicator light and/or a cornering light and/or a brake light and/or a tail light. Within the scope of the disclosure, it is conceivable, in principle, that at least one further vehicle light, in particular a ground projector and/or an ambient light, can be additionally controlled according to the control sequence. However, the additional vehicle light serves more to entertain and/or delight the person associated with the motor vehicle, but less to make said motor vehicle easier to locate.

It should be noted that, through user input or selection information, individual operating function indicator lights of a common operating light function can also be described as being operable individually, for example, with respect to the main headlights, the right and left main headlights can be selected individually. However, it is of course also possible to group operating function indicator lights, for example, by operating light functions in order to make them selectable together for example, in a user interface where user input is made.

As already mentioned, the request signal can in particular be an unlock signal or a locate signal. An unlock signal can be generated, for example, by actuating an operating element on a vehicle key associated with the motor vehicle, by actuating an operating element in an app on a mobile device, in particular a mobile phone, and/or when a device associated with the motor vehicle as a key enters an unlocking area of the motor vehicle. A special locate signal, which can be generated via corresponding operating elements of the vehicle key and/or the app and which can be generated by the person associated with the motor vehicle when searching for the motor vehicle, is also conceivable. The person can then trigger the control sequence at any time when searching for their motor vehicle, regardless of unlocking.

Generally speaking, the disclosure therefore enables a customization for recognizing and locating the motor vehicle using simple, clearly recognizable or perceptible means already provided in the motor vehicle for the realization of operating function indicator lights to be used during operation of the motor vehicle since at least the operating function indicator lights to be used can be selected by the user.

In an advantageous refinement of the present disclosure, it can be provided that the control sequence for a plurality of operating function indicator lights to be operated comprises a sequence in which each operating function indicator light to be operated is assigned at least one operating period within a total duration of the control sequence, wherein the control unit is also configured to set the sequence according to the selection information. In this case, the term “sequence” is generally to be understood broadly, meaning that operating periods of different operating function indicator lights can also overlap completely or partially. Multiple operating periods are also possible for a specific operating function indicator light if it is to be utilized multiple times over the control sequence. Thus, with the already advantageous option of selecting a plurality of operating function indicator lights, it is also possible for the user, i.e., the person associated with the motor vehicle, to select the sequence of their operation in the control sequence and thus also to further customize it in a simple manner.

Expedient refinements of the present disclosure can further provide that the control sequence for at least one of the at least one operating function indicator light to be controlled comprises at least one brightness and/or brightness profile, in particular a flashing frequency and/or a dimming profile, and that the control unit is configured to set the brightness and/or brightness profile according to the selection information. This provides further customization options that utilize capabilities already provided on the motor vehicle for easily implementable and assignable, easily recognizable or perceptible light signals.

Overall, the control sequence, which can be understood as a greeting sequence or activation and deactivation sequence with respect to the operating function indicator lights, can be realized in exemplary embodiments not only by the selection of the operating function indicator lights, which can be understood as exterior light actuators, but also, for example, by flashing frequency, light intensity, dimming profile, and sequence. It should be noted that for operating function indicator lights that can be operated in multiple colors, the selection information can also comprise a color selection, which the control unit can implement accordingly in the control sequence.

In some configurations of the present disclosure, it can be provided that the motor vehicle has a user interaction device providing a user interface, in particular on a touchscreen, which is designed to provide a depiction for receiving user input in the user interaction device. For example, such a user interface can be provided on an on-board computer or another central control point, for example in the area of the center console. Modern motor vehicles often have touchscreens there, which offer various setting options in various depictions, for example structured in a menu structure. The capability for user input regarding the control sequence and thus for determining the selection information can also be integrated into such a user interface.

In a particularly advantageous refinement of the present disclosure, it can be provided that the motor vehicle comprises a storage in which a plurality of control sequence data sets are stored and user input comprises the selection of one of these control sequence data sets as the control sequence to be used. It is therefore conceivable to offer a user, i.e., the person associated with the motor vehicle, a certain number of predefined control sequences for selecting a control sequence to be used, which further significantly simplifies setting and customization. For example, the control sequence data sets can be provided by the manufacturer as suggestions and/or downloaded by the motor vehicle via a communications link, in particular to the Internet. For example, further, also visually particularly pleasing control sequence data sets can be offered in a shop or the like.

In such a context, it can specifically be provided that the user interaction device is designed to offer the control sequence data sets for selection in the user interface. In this regard, it is particularly advantageous if the user interaction device is designed to depict an animation visualizing the resulting operation of the at least one operating function indicator light to be controlled of a selected control sequence data set. For example, a virtual top view of the motor vehicle and/or a front view and/or a rear view of the motor vehicle can be used as the basis for the visualizing animation, based on which the user can get an idea of the corresponding control sequence of the control sequence data set and thus make a well-founded, informed decision. It should be noted that such a visualizing animation is of course also conceivable if a user can configure a control sequence themselves in the user interface, for example by setting corresponding parameters of the control sequence. The user can then be given the opportunity at any time in the user interface, for example by way of a control element “Visualize control sequence”, to obtain a visual impression of the set parameters, in particular comprising the selected operating function indicator lights to be controlled and their sequence.

The motor vehicle can expediently have a communication device for communicating with a mobile device external to the motor vehicle, in particular associated with a driver of the motor vehicle, which is designed to receive the selection information from the mobile device. The selection information can therefore also be input using a mobile device and transmitted to the motor vehicle. For example, a user interface of an app of the mobile device, in particular a mobile phone, can comprise a depiction via which user input can be received. A visual animation can of course also be implemented external to the motor vehicle on the mobile device, as described above. The motor vehicle and the mobile device can be understood as a communication arrangement that cooperatively enables the input, setting, and implementation of the control sequence.

In addition to the motor vehicle, the present disclosure also relates to a computer-implemented method for operating a lighting arrangement of a motor vehicle having a plurality of operating function indicator lights, each of which is associated with one of a plurality of operating light functions and is provided on the exterior of the motor vehicle, wherein a control unit is provided for controlling the operation of the operating function indicator lights, and the control unit controls at least one of the operating function indicator lights according to a control sequence when the motor vehicle is stationary and upon presentation of a request signal. According to the disclosure, such a method provides that the control unit selects the at least one operating function indicator light to be operated according to the control sequence on the basis of selection information describing user input.

All statements regarding the motor vehicle according to the disclosure can be transferred analogously to the method according to the disclosure, and vice versa, so that the advantages already mentioned can also be obtained with the method.

### BRIEF DESCRIPTION OF THE SEVERAL VIEWS OF THE DRAWINGS

Further advantages and details of the present disclosure will become apparent from the exemplary embodiments described below and from the drawings.

FIG. 1 shows a schematic diagram of a motor vehicle according to the disclosure.

FIG. 2 shows a flowchart of an exemplary embodiment of the method according to the disclosure.

FIG. 3 shows a depiction with a visualizing animation in a user interface.

### DETAILED DESCRIPTION

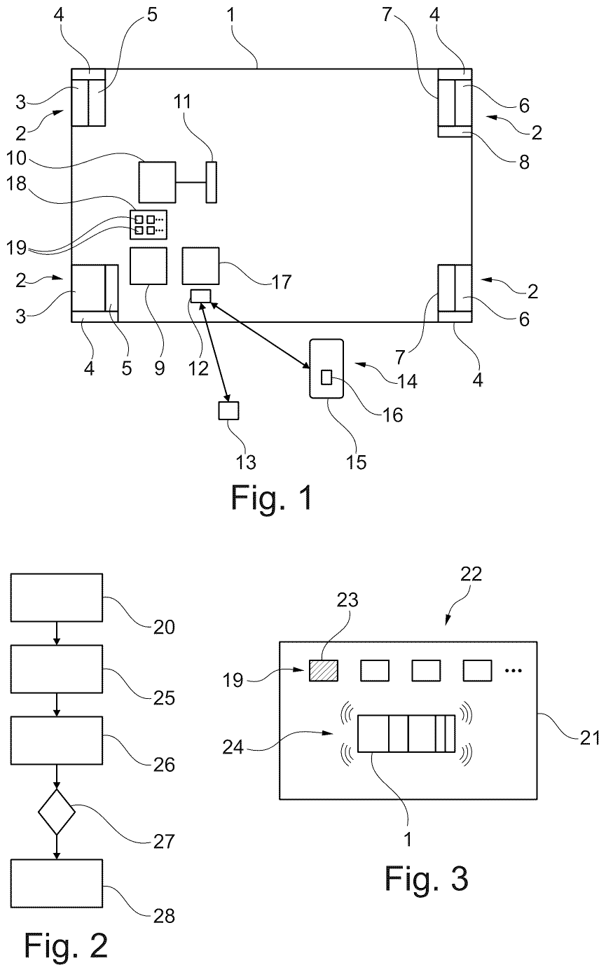

FIG. 1 shows a schematic diagram of a motor vehicle 1 according to the disclosure. Motor vehicle 1 comprises a lighting arrangement with a plurality of operating function indicator lights 2, wherein, in the present case, main headlights 3, direction indicator lights 4, daytime running lights and position lights 5, tail lights 6, brake lights 7, and a reversing light 8 are shown by way of example. The operation of the lighting arrangement is controlled by a control unit 9. The motor vehicle also has a user interaction device 10, which in the present case comprises a touchscreen 11, for example, in the area of a center console.

A communication device 12 enables the establishment of communication links, for example, to a key 13 belonging to the motor vehicle 1 and/or to a mobile device 14 not belonging to motor vehicle 1 but associated with it, in this case a mobile phone 15, on which an app 16 is installed for operating and/or retrieving information relating to motor vehicle 1. A locking system control unit 17 can utilize communication data of communication device 12, for example, to control locking devices of motor vehicle 1, but in particular also, under certain conditions, to generate a request signal to lighting arrangement control unit 9. The request signal can be an unlock signal, which is generated, for example, by control unit 17 when an unlocking control element of the key 13 has been actuated, an unlocking function has been selected in app 16, and/or key 13 and/or mobile device 14, as key devices, are located within an unlocking range around motor vehicle 1. However, the request signal can also be a locate signal, which can be triggered, for example, via other respective operating elements of key 13 and/or mobile device 14 in order to locate one's own motor vehicle, for example in a large parking lot.

If control unit 9 receives the request signal and the motor vehicle is stationary, in particular parked, control unit 9 controls at least one of operating function indicator lights 2 according to a control sequence that was generated or selected according to selection information describing user input. User input can be made, for example, via user interaction device 10, specifically a user interface of touchscreen 11, but also in app 16 of mobile device 14. In the present case, control unit 9 can specify in the control sequence based on user input which of operating function indicator lights 2 are to be controlled to emit light signals, in which sequence, i.e., in which operating periods of an overall duration of the control sequence. In addition, the user can also specify, through user input and thus the selection information, with which brightness and/or brightness profile (e.g., flashing frequency, dimming profile, etc.) the function control elements are to be operated. For this purpose, suitable depictions can be provided in the user interfaces of user interaction device 10 and/or app 16, which in particular can also comprise visualizing animations with regard to the currently set or selected parameters of the control process.

In some embodiments, motor vehicle 1 also comprises a storage 18 in which a plurality of predefined control sequence data sets 19, each of which describes a predefined control sequence, are stored. User input can relate to the selection of one of these control sequence data sets 19. Of course, it is also conceivable for user input to initially relate to a selection of a control sequence data set 19, which is then further adjusted in at least one parameter.

FIG. 2 shows a flowchart of an exemplary embodiment of the method according to the disclosure, as it can be carried out using control unit 9 and user interaction device 10/app 16 of mobile device 14. In a step 20, user interaction device 10 or mobile device 14 is operated such that user input can be made in the respective user interface, specifically the depiction related to the control sequence, and the selection information can be generated based thereon. Accordingly, the corresponding depictions are generated and, if appropriate, visualizing animations are output, operating elements are provided, and actuations thereof are evaluated.

FIG. 3 shows, purely by way of example, a possible depiction 21 in a user interface 22 which serves to receive user input. In an upper area thereof, control sequence data sets 19 are offered for activation and selection, with control sequence data set 23 being selected for visualization in the present case, as indicated by the hatching. In the lower area of depiction 21, this selected control sequence data set 23 is correspondingly visualized in a visualizing animation 24. In the present case, a schematic top view of motor vehicle 1 is shown with operating function indicator lights 2 virtually illuminated in accordance with the control sequence, in particular the sequence. Upon activation, if required, other views (front view or rear view) can also be available for the dynamic, visualizing animation.

Returning to FIG. 2, the selection information compiled in step 20 and describing user input is received by control unit 9 in step 25. Control unit 9 evaluates the selection information in a step 26 to determine the control sequence, in particular to determine the at least one operating function indicator light 2 to be operated according to the control sequence, and the additional parameters. If necessary, when selecting a control sequence data set 19, this can also be retrieved from storage device 18.

With motor vehicle 1 being stationary, a step 27 then monitors whether the request signal is present in control unit 9. If this is the case, operating function indicator lights 2 are controlled in step 28 according to the determined control sequence. This allows the person associated with the motor vehicle to reliably locate their own motor vehicle 1, even if there are many motor vehicles, especially those of the same manufacturer and/or model.

German patent application no. 102024138430.1, filed Dec. 17, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A motor vehicle comprising:
a plurality of operating function indicator lights, each of which is associated with one of a plurality of operating light functions and provided on an exterior of the motor vehicle; and
a control unit for controlling the operation of the operating function indicator lights,
wherein the control unit is designed to control at least one of the operating function indicator lights according to a control sequence when the motor vehicle is stationary and upon presentation of a request signal, and
wherein the control unit is configured to select the at least one operating function indicator light to be operated according to the control sequence on the basis of selection information describing user input.

2. The motor vehicle according to claim 1, wherein the operating function indicator lights (2) comprise at least one headlight and/or at least one direction indicator and/or at least one tail light and/or at least one brake light and/or at least one position light, and/or the at least one operating light function comprises a low beam and/or a high beam and/or a position light and/or a direction indicator light and/or a cornering light and/or a brake light and/or a tail light.

3. The motor vehicle according to claim 1, wherein the control sequence for the plurality of operating function indicator lights to be operated comprises a sequence in which each operating function indicator light to be operated is assigned at least one operating period within a total duration of the control sequence, wherein the control unit is also configured to set the sequence according to the selection information.

4. The motor vehicle according to claim 1, wherein the control sequence for at least one of the at least one operating function indicator light to be controlled comprises at least one brightness and/or one brightness profile, in particular a flashing frequency, and the control unit is configured to set the brightness and/or the brightness profile according to the selection information.

5. The motor vehicle according to claim 1, wherein the motor vehicle has a user interaction device providing a user interface, in particular on a touchscreen, which is designed to provide a depiction for receiving user input in the user interaction device.

6. The motor vehicle according to claim 1, wherein the motor vehicle comprises a storage in which a plurality of control sequence data sets are stored and user input comprises a selection of one of these control sequence data sets as the control sequence to be used.

7. The motor vehicle according to claim 5, wherein the user interaction device is designed to depict an animation visualizing the resulting operation of the at least one operating function indicator light to be controlled of a selected control sequence data set.

8. The motor vehicle according to claim 1, wherein the motor vehicle further comprises a communication device for communicating with a mobile device external to the motor vehicle, in particular associated with a driver of the motor vehicle, which is designed to receive the selection information from the mobile device.

9. The motor vehicle according to claim 1, wherein the request signal is an unlock signal or a locate signal.

10. A computer-implemented method for operating a lighting arrangement of a motor vehicle having a plurality of operating function indicator lights, each of which is associated with one of a plurality of operating light functions and is provided on an exterior of the motor vehicle, and having wherein a control unit for controlling operation of the operating function indicator lights, the method comprising:
controlling at least one of the operating function indicator lights according to a control sequence when the motor vehicle is stationary and upon presentation of a request signal, wherein the control unit selects the at least one operating function indicator light to be operated according to the control sequence on the basis of selection information describing user input.
